(19) United States
(12) Patent Application Publication
(10) Pub. No.: US 2006/0114053 A1
(43) Pub. Date: Jun. 1, 2006

(54) Charge-pump-type power supply circuit

(75) Inventors: Yasuyuki Sohara, Tokyo (JP); Masayasu Tanaka, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Renesas Technology Corp., Tokyo (JP)

(21) Appl. No.: 11/268,484

(22) Filed: Nov. 8, 2005

(30) Foreign Application Priority Data
Nov. 30, 2004 (JP) 2004-347520

(51) Int. Cl. G05F 1/10

(52) U.S. Cl. 327/536

(57) ABSTRACT

Two charge pump circuits are connected in a cascade manner. Each of the charge pump circuits includes two charging switches and two voltage-boosting switches. A voltage-boosting switch, provided on a side for adding a boosting voltage to a charging voltage in a second-stage charge pump circuit, includes a plurality of switches. One ends of the switches are commonly connected to a capacitor. Different boosting voltages are applied to other ends of the switches. A selecting unit selects one of the switches, during a boosting period, based on an input voltage or an output voltage to or from a first-stage charge pump circuit.

### BACKGROUND OF THE INVENTION

1. Field of the Invention

The present invention relates to a charge-pump-type power supply circuit that boosts an input voltage with charging and discharging of a capacitor, and more particularly, to a charge-pump-type power supply circuit that can obtain a high voltage by a multistage cascaded-connection.

2. Description of the Related Art

Generally, a charge-pump-type power supply circuit uses a metal-oxide semiconductor (MOS) transistor for a switch forming a charging path and a discharging path, and boosts a voltage by applying an input voltage to a charging capacitor through the charging path to accumulate charges, applying the input voltage to the charging capacitor through the discharging path to add charges to the accumulated charges, and transferring total charges to an output capacitor. A conventional charge-pump-type power supply circuit is disclosed in, for example, Japanese application patent laid-open publication No. 11-150943, and Japanese application patent laid-open publication No. 2001-309641. Because the output voltage obtained is twice the input voltage, to obtain an even higher voltage, a configuration of a multistage cascaded-connection of the charge-pump-type power supply circuit is employed. For an easy understanding of the present invention, a two-stage-cascaded charge-pump-type power supply circuits will be described.

FIG. 8 is a circuit diagram of the basic configuration of the charge-pump-type power supply circuit in a two-stage configuration according to a conventional technology. A first-stage charge-pump-type power supply circuit (hereinafter, “charge pump circuit”) CP1 and a second-stage charge pump circuit CP2 have the same configuration. The charge pump circuit CP1 includes charging switches (PMOS transistor Q11, NMOS transistor Q12) forming a charging path, discharging switches (NMOS transistor Q13, PMOS transistor Q14) forming a discharging path, a charging capacitor C11, and an output capacitor C12.

On the charging side of the charge pump circuit CP1, an input voltage Vin is applied to a source of the PMOS transistor Q11, and a drain of the PMOS transistor Q11 is connected to one electrode of the charging capacitor C11. A drain of the NMOS transistor Q12 is connected to the other electrode of the charging capacitor C11. A source of the NMOS transistor Q12 is connected to the ground. A control circuit (not-shown) generates a charging control signal TC1 that is directly applied to the gate of the NMOS transistor Q12. The signal TC1 is also applied via an inverter Q51 to the gate of the PMOS transistor Q11.

On the discharging side of the charge pump circuit CP1, the input voltage Vin is applied to a source of the NMOS transistor Q13, and a drain of the NMOS transistor Q13 is connected to the other electrode of the charging capacitor C11. A source of the PMOS transistor Q14 is connected to the one electrode of the charging capacitor C11. The output capacitor C12 is connected to a drain of the PMOS transistor Q14 and the ground. An inverter Q71 inverts the charging control signal TC1 into a discharge control signal TD1 that is directly applied to the gate of the NMOS transistor Q13. The signal TD1 is also applied via an inverter Q61 to a gate of the PMOS transistor Q14.

The charge pump circuit CP2 includes charging switches (PMOS transistor Q21, NMOS transistor Q22) forming a charging path, discharging switches (NMOS transistor Q23, PMOS transistor Q24) forming a discharging path, a charging capacitor C21, and an output capacitor C22.

On the charging side of the charge pump circuit CP2, a source of the PMOS transistor Q21 is connected to the drain of the PMOS transistor Q14 in the charge pump circuit CP1. A drain of the PMOS transistor Q21 is connected to one electrode of the charging capacitor C21. A drain of the NMOS transistor Q22 is connected to the other electrode of the charging capacitor C21. A source of the NMOS transistor Q22 is connected to the ground. The charging control signal TC1 is applied to a gate of the NMOS transistor Q22, and to a gate of the PMOS transistor Q21 via an inverter Q52.

On the discharging side of the charge pump circuit CP2, a source of the NMOS transistor Q23 is connected to the drain of the PMOS transistor Q14 in the charge pump circuit CP1. A drain of the NMOS transistor Q23 is connected to the other electrode of the charging capacitor C21. A source of the PMOS transistor Q24 is connected to the one electrode of the charging capacitor C21. The output capacitor C22 is arranged between a drain of the PMOS transistor Q24 and the ground. The inverter Q71 inverts the charging control signal TC1 into the discharge control signal TD1 that is directly applied to a gate of the NMOS transistor Q23. The signal TC1 is also applied to a gate of the PMOS transistor Q24 via an inverter Q62.

FIG. 9 is a timing chart illustrating the voltage boosting operation of the charge-pump-type power supply circuit shown in FIG. 8. The charging control signal TC1 and the discharge control signal TD1 are binary signals, alternately repeating a high-level period and a low-level period with the same duty ratio with different polarities. The signals allow the charge pump circuit CP1 and charge pump circuit CP2 to switch alternately the charging path and discharging path at the same constant time interval.

In the charge pump circuit CP1 and the charge pump circuit CP2, the PMOS transistors Q11, Q21 and the NMOS transistors Q12, Q22 are ON during a charging period in which the charging control signal TC1 is at a logical high (Hi) level and the discharge control signal TD1 is at a logical low (Lo) level. On the other hand, the NMOS transistors Q13, Q23 and the PMOS transistors Q14, Q24 are ON during a discharging period in which the discharge control signal TD1 is at the Hi level and the charging control signal TC1 is at the Lo level.

During the charging period, the PMOS transistor Q11 and the NMOS transistor Q12 are ON in a series circuit formed with the PMOS transistor Q11, the charging capacitor C11, and the NMOS transistor Q12 between the input power supply Vin and ground, and a charging current I11 flows to charge the charging capacitor C11 up to a voltage VC11.

During the discharging period, the NMOS transistor Q13 and the PMOS transistor Q14 are ON in a series circuit formed with the NMOS transistor Q13, the charging capacitor C11, the PMOS transistor Q14, and the output capacitor C12 between the input power supply Vin and the ground, and a discharge current I12 flows to perform a discharge operation (voltage boosting operation) in which a voltage obtained by adding the input power supply Vin to the charging voltage VC11 of the charging capacitor C11 is transferred to the output capacitor C12.

Because the charge pump circuit CP1 alternately performs the charging and discharging operations as above, an output voltage Vout1 (2×Vin) corresponding to twice the input power-supply voltage Vin is obtained at the output capacitor C12.

The charge pump circuit CP2 also operates in a similar manner. During the charging period, a terminal voltage Vout1 across the output capacitor C12 causes a charging current I21 to charge the charging capacitor C21 up to a voltage VC21. During the discharging period, a voltage boosting operation is performed in which a voltage obtained by adding the terminal voltage Vout1 to a charging voltage VC21 of the charging capacitor C21 is transferred to the output capacitor C22. With a repetition of the above procedures, if there is no voltage loss, an output voltage Vout2 (4×Vin) corresponding to four times the input voltage Vin is obtained at the output capacitor C22.

However, in the conventional multistage-cascade-connected charge-pump-type power supply circuits, because a second or a subsequent stage circuit simply doubles the input voltage, the output voltage is proportional to the number of the cascaded stages. As a result, an amount of a change of the output voltage becomes large with respect to an amount of a change of the input voltage. In addition, the output voltage at the same output terminal varies considerably with a change of the input voltage. Therefore, the circuit needs to be formed with an element that can withstand the maximum input voltage, which results in an increase in a circuit size.

To solve the above problems, the conventional multistage-cascaded charge pump circuits adopt, for example, a constant voltage circuit inserted in a path for applying the input voltage to stabilize the input voltage. However, because this structure considerably deteriorates an efficiency of the power supply.

### SUMMARY OF THE INVENTION

It is an object of the present invention to at least solve the problems in the conventional technology.

A charge-pump-type power supply circuit according to one aspect of the present invention includes two charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. One of the voltage-boosting switches, which is provided on a side for adding the boosting voltage to the charging voltage in a second-stage charge pump circuit, includes a plurality of switches. One ends of the switches are commonly connected to the capacitor, and different boosting voltages are applied to other ends of the switches, respectively. The selecting unit is configured to select one of the switches, during a boosting period, based on the input voltage to a first-stage charge pump circuit or an output voltage from the first-stage charge pump circuit.

A charge-pump-type power supply circuit according to another aspect of the present invention includes two charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. One of the charging switches, which is provided on a high-voltage side for charging the capacitor in a second-stage charge pump circuit, includes a plurality of switches. One ends of the switches are commonly connected to the capacitor, and different charging voltages are applied to other ends of the switches, respectively. The selecting unit is configured to select one of the switches, during a charging period, based on the input voltage to a first-stage charge pump circuit or an output voltage from the first-stage charge pump circuit.

A charge-pump-type power supply circuit according to still another aspect of the present invention includes two charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. Each of a second-stage charge pump circuit and a third-stage charge pump circuit includes a first configuration or a second configuration. The first configuration is such that one of the voltage-boosting switches, which is provided on a side for adding the boosting voltage to the charging voltage, includes a plurality of switches, one ends of the switches are commonly connected to the capacitor, and different boosting voltages are applied to other ends of the switches, respectively. The second configuration is such that one of the charging switches, which is provided on a high-voltage side for charging the capacitor, includes a plurality of switches, one ends of the switches are commonly connected to the capacitor, and different boosting voltages are applied to other ends of the switches, respectively. The selecting unit configured to select one of the switches in the second-stage charge pump circuit and the third-stage charge pump circuit, during a boosting period or a charging period, based on the input voltage to a first-stage charge pump circuit or an output voltage from the first-stage charge pump circuit.

A charge-pump-type power supply circuit according to still another aspect of the present invention includes a plurality of charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. One of the voltage-boosting switches, which is provided on a side for adding the boosting voltage to the charging voltage in a second-stage charge pump circuit and subsequent-stage charge pump circuits, includes a plurality of switches. One ends of the switches are commonly connected to the capacitor, and different boosting voltages are applied to other ends of the switches, respectively. The selecting unit configured to select one of the switches, during a boosting period, based on at least the input voltage to a first-stage charge pump circuit or an output voltage from the first-stage charge pump circuit.

A charge-pump-type power supply circuit according to still another aspect of the present invention includes a plurality of charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. One of the charging switches, which is provided on a high-voltage side for charging the capacitor in a second-stage charge pump circuit and subsequent-stage charge pump circuits, includes a plurality of switches. One ends of the switches are commonly connected to the capacitor, and different charging voltages are applied to other ends of the switches, respectively. The selecting unit configured to select one of the switches, during a charging period, based on at least the input voltage to a first-stage charge pump circuit or an output voltage from the first-stage charge pump circuit.

A charge-pump-type power supply circuit according to still another aspect of the present invention includes a plurality of charge pump circuits connected in a cascade manner and a selecting unit. Each of the charge pump circuits includes two charging switches configured to charge a capacitor up to an input voltage; and two voltage-boosting switches configured to add the input voltage to a charging voltage of the capacitor as a boosting voltage. Each of a second-stage charge pump circuit and subsequent-stage charge pump circuits includes a first configuration or a second configuration. The first configuration is such that one of the voltage-boosting switches, which is provided on a side for adding the boosting voltage to the charging voltage, includes a plurality of switches, one ends of the switches are commonly connected to the capacitor, and different boosting voltages are applied to other ends of the switches, respectively. The second configuration is such that one of the charging switches, which is provided on a high-voltage side for charging the capacitor, includes a plurality of switches, one ends of the switches are commonly connected to the capacitor, and different boosting voltages are applied to other ends of the switches, respectively. The selecting unit is configured to select one of the switches in the second-stage charge pump circuit and the subsequent-stage charge pump circuits, during a boosting period or a charging period, based on at least the input voltage to a first-stage charge pump circuit or an output voltage from the first-stage charge pump circuit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a circuit diagram of a charge-pump-type power supply circuit according to a first embodiment of the present invention;

FIG. 2 is a circuit diagram of a charge-pump-type power supply circuit according to a second embodiment of the present invention;

FIG. 3 is a circuit diagram of a charge-pump-type power supply circuit according to a third embodiment of the present invention;

FIG. 4 is a circuit diagram of a charge-pump-type power supply circuit according to a fourth embodiment of the present invention;

FIG. 5 is a circuit diagram of a charge-pump-type power supply circuit according to a fifth embodiment of the present invention;

FIG. 6 is a circuit diagram of a selection-signal generating circuit shown in FIG. 5;

FIG. 7 is a table for explaining a voltage boosting operation of the charge-pump-type power supply circuit shown in FIG. 5;

FIG. 8 is a circuit diagram of a charge-pump-type power supply circuit in a two-stage-cascaded configuration according to a conventional technology; and

FIG. 9 is a timing chart for illustrating a voltage boosting operation of the charge-pump-type power supply circuit shown in FIG. 8.

### DETAILED DESCRIPTION OF THE PREFERRED EMBODIMENTS

Exemplary embodiments of the present invention will be described in detail below with reference to the accompanying drawings.

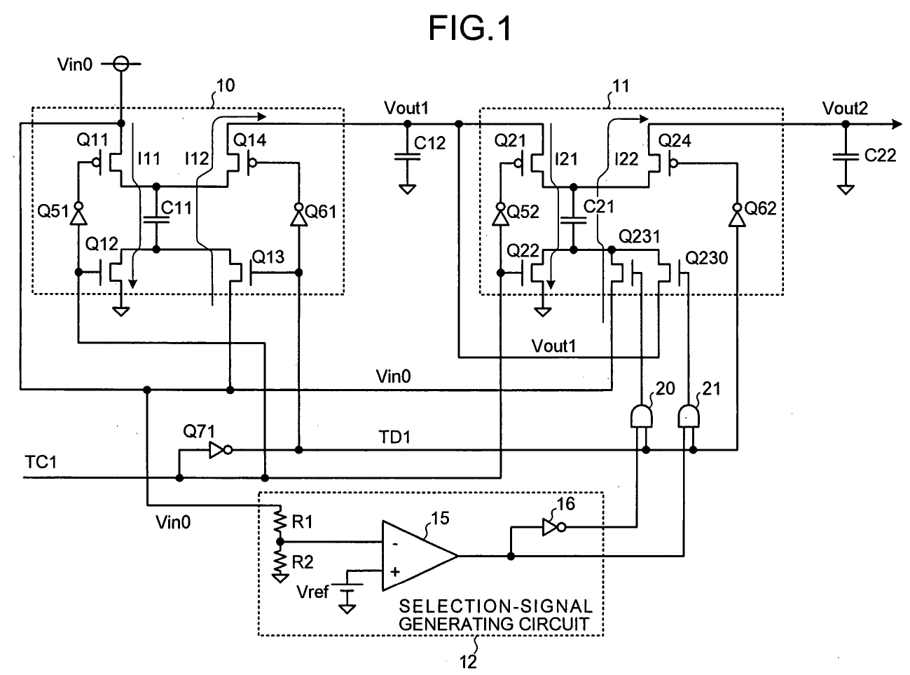

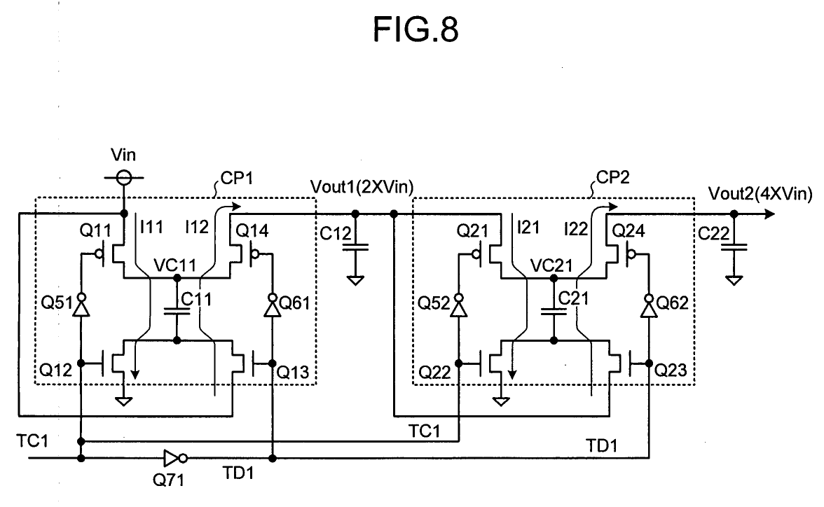

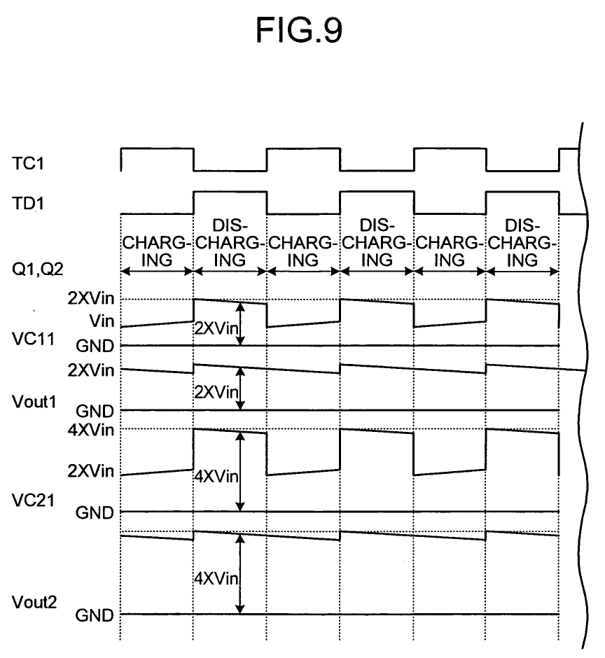

FIG. 1 is a circuit diagram of a charge-pump-type power supply circuit according to a first embodiment of the present invention, with an example of a two-stage-cascaded charge-pump-type power supply circuit. Note that, in FIG. 1, the same or equivalent components as those shown in FIG. 8 are referred to by the same reference numerals. The input power-supply voltage is indicated by Vin0 instead of Vin.

A first-stage charge pump circuit 10 corresponds to the charge pump circuit CP1 shown in FIG. 8, and the second-stage charge pump circuit 11 corresponds to the charge pump circuit CP2, in which the NMOS transistor Q23 on the discharging side is replaced by two NMOS transistors Q230, Q231 connected in parallel. The power supply circuit shown in FIG. 1 also includes a selection-signal generating circuit 12, and AND circuits 20, 21 forming a selection circuit.

An output voltage Vout1 from the first-stage charge pump circuit 10 is applied to a source of the NMOS transistor Q230, while the input voltage Vin0 is applied to a source of the NMOS transistor Q231.

The selection-signal generating circuit 12 includes a voltage dividing circuit that is formed with two resistors R1, R2 connected in series, a comparison circuit 15, a reference voltage source (Vref), and an inverter 16. In the voltage dividing circuit (R1, R2), one end of the resistor R1 is connected to a supplying line of the input voltage Vin0, and one end of the resistor R2 is connected to the ground. The other ends of the resistors R1, R2 are connected together to a negative (−) input of the comparison circuit 15. The reference voltage source (Vref) is connected to a positive (+) input of the comparison circuit 15. An output of the comparison circuit 15 is connected to one input of the AND circuit 21. The output is also connected to one input of the AND circuit 20 via the inverter 16. The discharge control signal TD1 from the inverter Q71 is applied to the other inputs of the AND circuit 20, 21. An output end of the AND circuit 20 is connected to a gate of the NMOS transistor Q231. An output end the AND circuit 21 is connected to a gate of the NMOS transistor Q230.

The first-stage charge pump circuit 10 outputs twice the input voltage Vin0 as the output voltage Vout1 to the second-stage charge pump circuit 11, as in the charge pump circuit CP1 shown in FIG. 8.

In the second-stage charge pump circuit 11, during a charging period with the charging control signal TC1 at a Hi level, a charging operation is performed in which the output voltage Vout1 (corresponding to twice the input voltage Vin0) from the first-stage charge pump circuit 10 charges the charging capacitor C21, as in the charge pump circuit CP2 shown in FIG. 8. However, during a discharging period with the discharge control signal TD1 at a Hi level, the circuit 11 selects a boosting voltage according to the level of the input voltage Vin0, rather than simply doubling the output voltage Vout1 from the first-stage charge pump circuit 10.

In the selection-signal generating circuit 12, the voltage dividing circuit (R1, R2), which is disposed between the supplying line of the input voltage Vin0 and the ground, provides a divided voltage to monitor a change of the level of the input voltage Vin0, as a monitor voltage. The comparison circuit 15 compares the monitor voltage from the voltage dividing circuit (R1, R2) with a reference voltage Vref. When the discharge control signal TD1 is at a Hi level, the following operation is performed according to a result of the comparison.

If the monitor voltage is less than the reference voltage Vref, the comparison circuit 15 outputs a Hi level. The AND circuit 21 thus outputs a Hi level and the AND circuit 20 outputs a Lo level, which turns ON the NMOS transistor Q230 and turns OFF the NMOS transistor Q231. As a result, the output voltage Vout1 (corresponding to twice the input voltage Vin0) from the first-stage charge pump circuit 10 is applied to the charging capacitor C21 as the boosting voltage. The output voltage Vout2 of the output capacitor C22 becomes four times the input voltage Vin0. This is the same as the voltage boosting operation of the charge pump circuit CP2 shown in FIG. 8.

On the other hand, if the monitor voltage is greater than the reference voltage Vref, the comparison circuit 15 outputs a Lo level. The AND circuit 20 thus outputs a Hi level and the AND circuit 21 outputs a Lo level, which turns ON the NMOS transistor Q231 and turns OFF the NMOS transistor Q230. As a result, the input voltage Vin0 is applied to the charging capacitor C21 as the boosting voltage. The output voltage Vout2 of the output capacitor C22 becomes three times the input voltage Vin0.

According to the first embodiment, depending on the input voltage level of the first-stage charge pump circuit, the second-stage charge pump circuit selects the boosting voltage added to the voltage-boosting basic voltage charged in the charging capacitor. Therefore, the boosting ratio of the output voltage can be changed according to the input voltage level. The charge-pump-type power supply circuit can thus directly receive the input voltage without stabilizing it, thereby preventing a reduction of the power supply efficiency. The change of the voltage boosting ratio of the output voltage is controlled in an opposite direction to the change of the input voltage level. The charge-pump-type power supply circuit can thus respond to the change of the input voltage without causing any problem with a withstand voltage of an element, which can contribute to a compact size of the circuit.

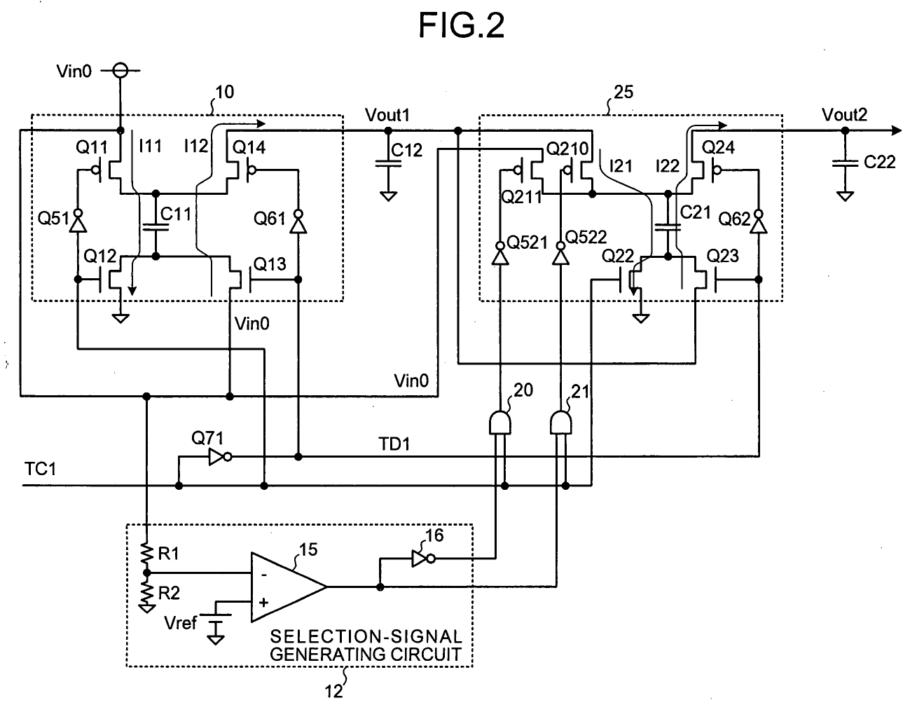

FIG. 2 is a circuit diagram of a charge-pump-type power supply circuit according to a second embodiment of the present invention. In FIG. 2, the same or equivalent components as those shown in FIG. 8 and FIG. 1 are referred to by the same reference numerals.

As shown in FIG. 2, the charge-pump-type power supply circuit according to the second embodiment includes a second-stage charge pump circuit 25 as a second-stage charge pump circuit instead of the second-stage charge pump circuit 11 shown in FIG. 1. The second-stage charge pump circuit 25 corresponds to the charge pump circuit CP2 shown in FIG. 8 in which the PMOS transistor Q21 on the charging side is replaced by two PMOS transistors Q210, Q211 connected in parallel.

The output voltage Vout1 from the first-stage charge pump circuit 10 is applied to a source of the PMOS transistor Q210. The input voltage Vin0 is applied to a source of the NMOS transistor Q211.

The charging control signal TC1 is applied to the AND circuit 20, 21. The AND circuit 20 provides an output that is applied via an inverter Q521 to a gate of the PMOS transistor Q211. The AND circuit 21 provides an output that is applied via an inverter Q522 to a gate of the PMOS transistor Q210. Other configurations are the same as shown in FIG. 1.

The first-stage charge pump circuit 10 outputs twice the input voltage Vin0 as the output voltage Vout1 to the second-stage charge pump circuit 11, as in the charge pump circuit CP1 shown in FIG. 8.

In the second-stage charge pump circuit 25, during the discharging period with the discharge control signal TD1 at a Hi level, the voltage boosting operation is performed in which the output-voltage Vout1 of the first-stage charge pump circuit 10 is added to the voltage-boosting basic voltage charged in the charging capacitor C21 during the charging period, to provide the output voltage Vout2 as the boosting voltage, as in the charge pump circuit CP2 shown in FIG. 8. However, the second-stage charge pump circuit 25 can select a boosting voltage added to the charging capacitor C21 according to a level of the input voltage Vin0.

If the monitor voltage of the input voltage Vin0 is less than the reference voltage Vref, the comparison circuit 15 outputs a Hi level. The AND circuit 21 thus outputs a Hi level and the AND circuit 20 outputs a Lo level, which turns ON the PMOS transistor Q210 and turns OFF the PMOS transistor Q211. As a result, the voltage-boosting basic voltage charged in the charging capacitor C21 is the output voltage Vout1 (corresponding to twice the input voltage Vin02) from the first-stage charge pump circuit 10. During the discharging period, the output voltage Vout1 (corresponding to twice the input voltage Vin0) from the first-stage charge pump circuit 10 is added to the voltage-boosting basic voltage as the boosting voltage. The output voltage Vout2 of the output capacitor C22 becomes four times the input voltage Vin0. This is the same as the voltage boosting operation of the charge pump circuit CP2 shown in FIG. 8.

On the other hand, if the monitor voltage is greater than the reference voltage Vref, the comparison circuit 15 outputs a Lo level. The AND circuit 20 thus outputs a Hi level and the AND circuit 21 outputs a Lo level, which turns ON the PMOS transistor Q211 and turns OFF the PMOS transistor Q210. As a result, the voltage-boosting basic voltage charged in the charging capacitor C21 is the input voltage Vin02 from the first-stage charge pump circuit 10. During the discharging period, the output voltage Vout1 (corresponding to twice the input voltage Vin0) from the first-stage charge pump circuit 10 is added to the voltage-boosting basic voltage as the boosting voltage. The output voltage Vout2 of the output capacitor C22 becomes three times the input voltage Vin0.

According to the second embodiment, depending on the input voltage level of the first-stage charge pump circuit, the second-stage charge pump circuit selects the voltage-boosting basic voltage charged in the charging capacitor, to which the boosting voltage is added. Therefore, the voltage boosting ratio of the output voltage can be changed according to the input voltage level, as in the first embodiment, providing the same operational advantage as in the first embodiment.

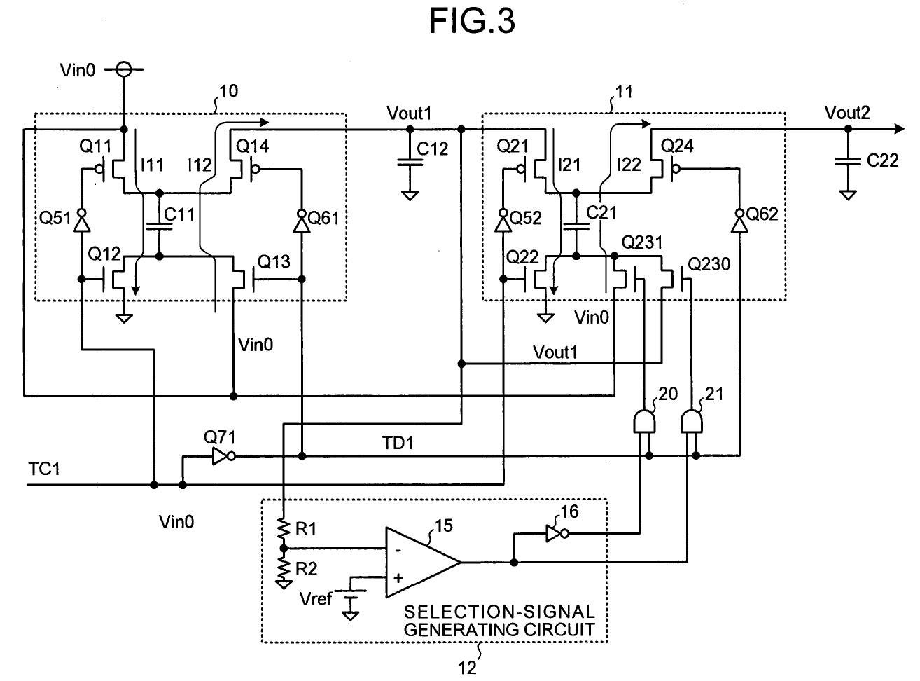

FIG. 3 is a circuit diagram of a charge-pump-type power supply circuit according to a third embodiment of the present invention. In FIG. 3, the same or equivalent components as those shown in FIG. 1 are referred to by the same reference numerals.

In the charge-pump-type power supply circuit according to the third embodiment, the voltage dividing circuit (R1, R2) of the selection-signal generating circuit 12 monitors the output voltage Vout1 of the first-stage charge pump circuit 10 instead of the input voltage Vin0.

According to this configuration, the same operational advantage as in the first embodiment and the monitor voltage corresponds to twice the input voltage Vin0 are provided, which can double the inversion accuracy of the comparison circuit in the selection-signal generating circuit 12.

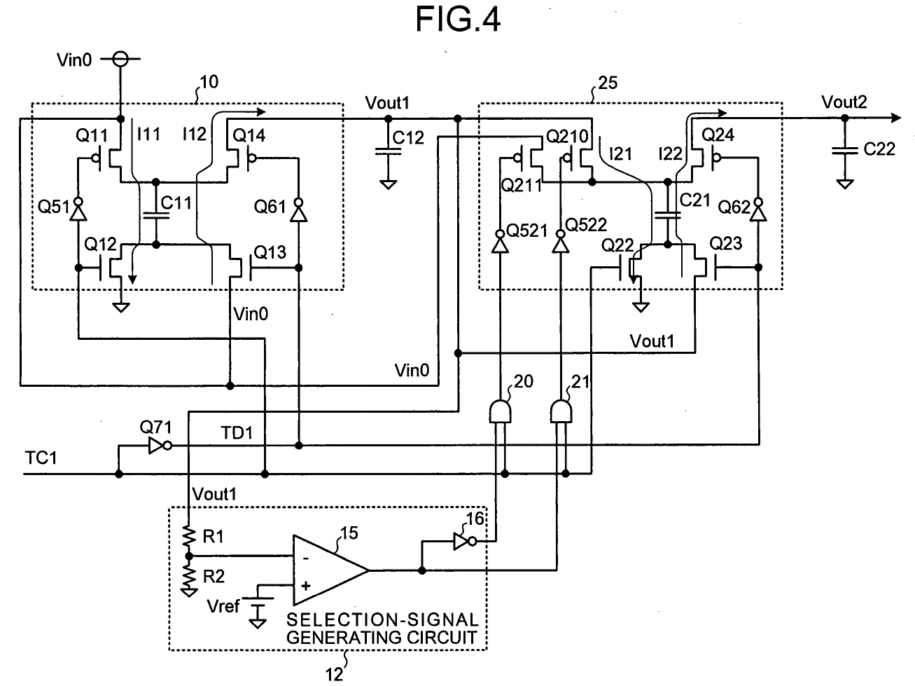

FIG. 4 is a circuit diagram of a charge-pump-type power supply circuit according to a fourth embodiment of the present invention. In FIG. 4, the same or equivalent components as those shown in FIG. 2 are referred to by the same reference numerals.

In the charge-pump-type power supply circuit according to the fourth embodiment, the voltage dividing circuit (R1, R2) of the selection-signal generating circuit 12 monitors the output voltage Vout1 of the first-stage charge pump circuit 10 instead of the input voltage Vin0.

According to this configuration, the same operational advantage as in the second embodiment and the monitor voltage corresponds to twice the input voltage Vin0 are provided, which can double the inversion accuracy of the comparison circuit in the selection-signal generating circuit 12.

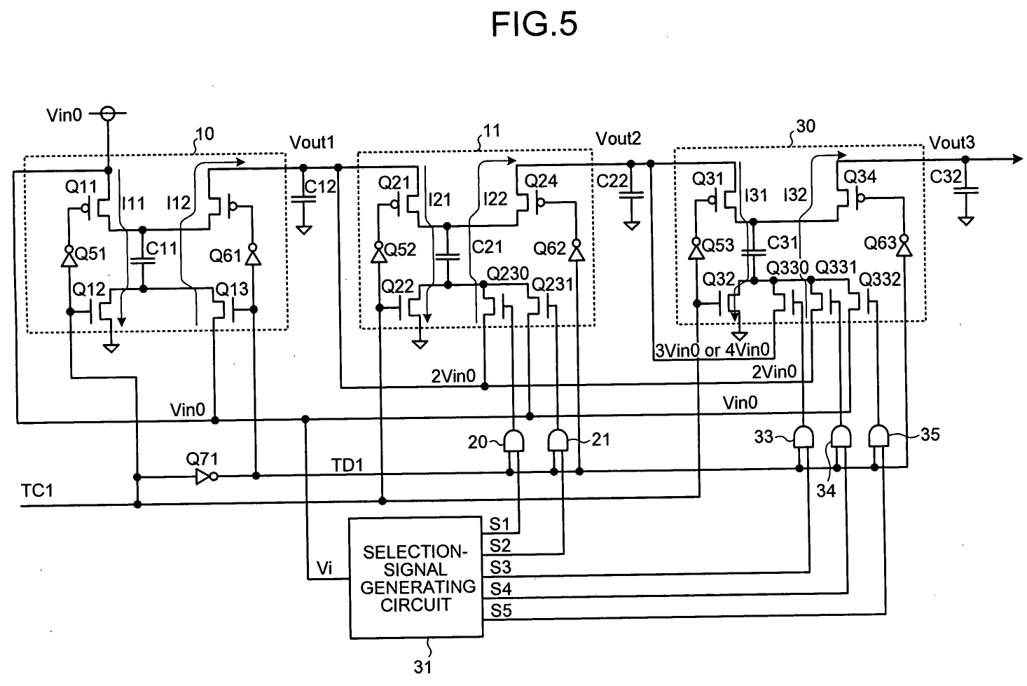

FIG. 5 is a circuit diagram of a charge-pump-type power supply circuit according to a fifth embodiment of the present invention. In FIG. 4, the same or equivalent components as those shown in FIG. 1 are referred to by the same reference numerals.

The second embodiment shows a configuration example of three or more stage charge pump circuits connected. FIG. 5 shows a configuration corresponding to that shown in FIG. 1 with a third-stage charge pump circuit 30 added. The selection-signal generating circuit 12 is replaced by a selection-signal generating circuit 31. In addition, three of AND circuits 33, 34, and 35 are employed as the selection circuit.

The charge pump circuit 30 includes charging switches (PMOS transistor Q31, NMOS transistor Q32) forming the charging path, discharging switches (NMOS transistor Q330, Q331, and Q332, and PMOS transistor Q34) forming the discharging path, a charging capacitor C31, and an output capacitor C32.

On the charging side of the charge pump circuit 30, the output voltage Vout2 from the previous-stage charge pump circuit 11 is applied to a source of the PMOS transistor Q31. A drain of the PMOS transistor Q31 is connected to one electrode of the charging capacitor C31. A drain of the NMOS transistor Q32 is connected to the other electrode of the charging capacitor C31. A source of the NMOS transistor Q32 is connected to the ground. The charge control signal TC1 is directly applied to a gate of the NMOS transistor Q32. The signal TC1 is also applied via an inverter Q53 to a gate of the PMOS transistor Q31.

On the discharging side of the charge pump circuit 30, drains of the NMOS transistors Q330, Q331, and Q332 are connected together to the other electrode of the charging capacitor C31. The output voltage Vout2 from the second-stage charge pump circuit 11 is applied to a source of the NMOS transistor Q330. The output voltage Vout1 from the first-stage charge pump circuit 10 is applied to a source of the NMOS transistor Q331. The input voltage Vin0 is applied to a source of the NMOS transistor Q332. A source of the PMOS transistor Q34 is connected to the one electrode of the charging capacitor C31. An output capacitor C32 is provided between the drain of the PMOS transistor Q34 and the ground is an.

The discharge control signal TD1 output from the inverter Q71 is applied to a gate of the PMOS transistor Q34 via an inverter Q63, The output from the AND circuit 33 is applied to agate of the NMOS transistor Q330. The output from the AND circuit 34 is applied to a gate of the NMOS transistor Q331. The output from the AND circuit 35 is applied to a gate of the NMOS transistor Q332.

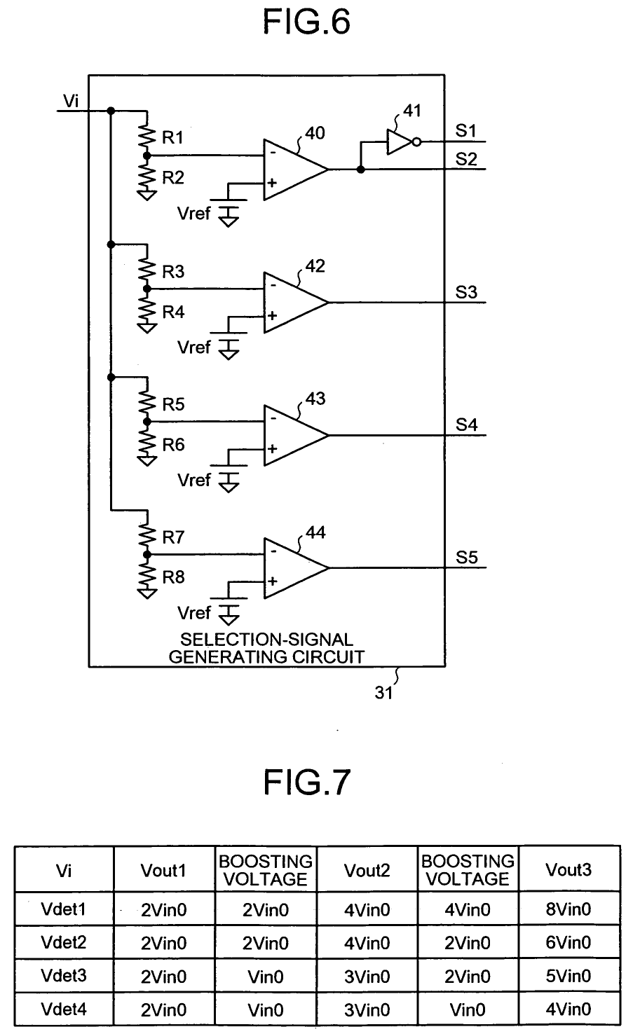

The selection-signal generating circuit 31 is configured as shown in FIG. 6, for example, and generates five selection control signals S1 to S5 from the input voltage Vin0 as the input voltage Vi. The selection control signals S1 to S5 are applied to each of one input ends of the AND circuits 20, 21, and 33 to 35, respectively. The discharge control signal TD1 is applied to each of the other input ends of the AND circuits 20, 21, and 33 to 35.

FIG. 6 is a circuit diagram of a selection-signal generating circuit shown in FIG. 5. The selection-signal generating circuit 31 includes four voltage-dividing circuits (R1, R2), (R3, R4), (R5, R6), and (R7, R8) to monitor the input voltage Vi in parallel, four comparison circuits 40, 42, 43, and 44 to compare the corresponding monitor voltage and corresponding reference voltage Vref, and an inverter 41 that inverts the output of the comparison circuit 40. The output of the inverter 41 is the selection control signal S1. The outputs of the comparison circuits 40, 42, 43, and 44 are the selection control signals S2, S3, S4, and S5, respectively.

FIG. 7 is a table for explaining a voltage boosting operation of the charge-pump-type power supply circuit shown in FIG. 5. The input voltage Vi of the selection-signal generating circuit 31 is the detected voltage of the input voltage Vin0. The input voltage Vi falls into four levels of the detected voltage Vdet1 to Vdet4, as shown in FIG. 7. A relation between the detected voltages Vdet1 to Vdet4 is Vdet1<Vdet2<Vdet3<Vdet4. The voltage range is set such as the levels of the selection control signals S1 to S5 are as follows.

When the input voltage Vi is the detected voltage Vdet1, S1 is at the Hi level, S2 is at the Lo level, S3 is at the Hi level, and S4 and S5 are at the Lo level. When the input voltage Vi is the detected voltage Vdet2, S1 is at the Hi level, S2 and S3 are at the Lo level, S4 is at the Hi level, and S5 is at the Lo level. When the input voltage Vi is the detected voltage Vdet3, S1 is at the Lo level, S2 is at the Hi level, S3 is at the Lo level, S4 is at the Hi level, and S5 is at the Lo level. When the input voltage Vi is the detected voltage Vdet4, then S1 is at the Lo level, S2 is at the Hi level, S3 and S4 are at the Lo level, and S5 is at the Hi level.

During the discharging period in which the discharge control signal TD1 is at the Hi level, the output voltage Vout1 of the first-stage charge pump circuit 10 is 2Vin0 corresponding to twice the input voltage Vin0, for the detected voltages Vdet1 to Vdet4. For the detected voltages Vdet1 to Vdet4, the voltage boosting operation of the charge pump circuits 11, 30 is as follows.

When the input voltage Vi is equal to or larger than the detected voltage Vdet1, the AND circuit 20 outputs a Hi level, the AND circuit 21 outputs a Lo level, the AND circuit 33 outputs a Hi level, and the AND circuits 34, 35 output a Lo level. In the second-stage charge pump circuit 11, the NMOS transistor Q230 is turned ON, and in the charge pump circuit 30, the NMOS transistor Q330 is turned ON.

In the second-stage charge pump circuit 11, therefore, the boosting voltage of 2Vin0 is added to the voltage-boosting basic voltage of the charging capacitor C21, providing the output voltage Vout2 of 4Vin0. The voltage 4Vin0 is the voltage-boosting basic voltage charged in the charging capacitor C31 in the charge pump circuit 30. The output voltage Vout2=4Vin0 is then added to the voltage 4Vin0, providing the output voltage Vout3 of 8Vin0.

When the input voltage Vi is equal to or larger than the detected voltage Vdet2, the AND circuit 20 outputs a Hi level, the AND circuit 21 outputs a Lo level, the AND circuit 33 outputs a Lo level, the AND circuit 34 outputs a Hi level, and the AND circuit 35 outputs a Lo level. In the second-stage charge pump circuit 114, the NMOS transistor Q230 is turned ON, and in the charge pump circuit 30, the NMOS transistor Q331 is turned ON.

In the second-stage charge pump circuit 11, therefore, the boosting voltage of 2Vin0 is added to the voltage-boosting basic voltage of the charging capacitor C21, providing the output voltage Vout2 of 4Vin0. The voltage 4Vin0 is the voltage-boosting basic voltage which is charged in the charging capacitor C31 in the charge pump circuit 30. The output voltage Vout1=2Vin0 is then added to the voltage 4Vin0, providing the output voltage Vout3 of 6Vin0.

When the input voltage Vi is equal to or larger than the detected voltage Vdet3, the AND circuit 20 outputs a Lo level, the AND circuit 21 outputs a Hi level, the AND circuit 33 outputs a Lo level, the AND circuit 34 outputs a Hi level, and the AND circuit 35 outputs a Lo level. In the second-stage charge pump circuit 11, the NMOS transistor Q231 is turned ON, and in the charge pump circuit 30, the NMOS transistor Q331 is turned ON.

In the second-stage charge pump circuit 11, therefore, the boosting voltage of the input voltage Vin0 is added to the voltage-boosting basic voltage of the charging capacitor C21, providing the output voltage Vout2 of 3Vin0. The voltage 3Vin0 is the voltage-boosting basic voltage which is charged in the charging capacitor C31 in the charge pump circuit 30. The output voltage Vout1=2Vin0 is then added to the voltage 3Vin0, providing the output voltage Vout3 of 5Vin0.

When the input voltage Vi is equal to or larger than the detected voltage Vdet4, the AND circuit 20 outputs a Lo level, the AND circuit 21 outputs a Hi level, the AND circuit 33 outputs a Lo level, the AND circuit 34 outputs a Lo level, and the AND circuit 35 outputs a Hi level. In the second-stage charge pump circuit 11, the NMOS transistor Q231 is turned ON, and in the charge pump circuit 30, the NMOS transistor Q332 is turned ON.

In the second-stage charge pump circuit 11, the boosting voltage of the input voltage Vin0 is added to the voltage-boosting basic voltage of the charging capacitor C21, providing the output voltage Vout2 of 3Vin0. The voltage 3Vin0 is the voltage-boosting basic voltage which is charged in the charging capacitor C31 in the charge pump circuit 30. The input voltage Vin0 is then added to the voltage 3Vin0, providing the output voltage Vout3 of 4Vin0.

According to the fifth embodiment, when the second-stage charge pump circuit can provide the boosting voltage of three or four times the input voltage, the third-stage charge pump circuit can provide the boosting voltage selected from the three voltage levels of the input voltage Vin0, the output voltage Vout1 from the first-stage charge pump circuit, and the output voltage Vout2 from the second-stage charge pump circuit. The third-stage charge pump circuit can thus output a voltage of four to eight times the input voltage Vin0.

Note that although the fifth embodiment has been described with respect to an example of the application to the first embodiment, the fifth embodiment is also applicable to the second and the third embodiments. In this case, although both of the second- and the third-stage charge pump circuits may select the voltage on the charging side and discharging side, one circuit may select on the charging side, and the other circuit may select on the discharging side.

As seen from the description of the fifth embodiment, four or more stage charge pump circuits connected can be configured with reference to the fifth embodiment.

According to the first to the fifth embodiments, the selection-signal generating circuit uses the comparison circuit to make the selection control signal. The selection-signal generating circuit may have hysteresis characteristics, and may be any circuit that can detect the voltage.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charge-pump-type power supply circuit comprising:
two charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
one of the voltage-boosting switches, which is provided on a side for adding the boosting voltage to the charging voltage in a second-stage charge pump circuit, includes a plurality of switches,
one ends of the switches are commonly connected to the capacitor, and
different boosting voltages are applied to other ends of the switches, respectively; and
a selecting unit configured to select one of the switches, during a boosting period, based on the input voltage to a first-stage charge pump circuit or an output voltage from the first-stage charge pump circuit.

2. The charge-pump-type power supply circuit according to claim 1, wherein
the switches include two switches, and
the different boosting voltages include the input voltage to the first-stage charge pump circuit and the output voltage from the first-stage charge pump circuit.

3. A charge-pump-type power supply circuit comprising:
two charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
one of the charging switches, which is provided on a high-voltage side for charging the capacitor in a second-stage charge pump circuit, includes a plurality of switches,
one ends of the switches are commonly connected to the capacitor, and
different charging voltages are applied to other ends of the switches, respectively; and
a selecting unit configured to select one of the switches, during a charging period, based on the input voltage to a first-stage charge pump circuit or an output voltage from the first-stage charge pump circuit.

4. The charge-pump-type power supply circuit according to claim 3, wherein
the switches include two switches, and
the different charging voltages include the input voltage to the first-stage charge pump circuit and the output voltage from the first-stage charge pump circuit.

5. A charge-pump-type power supply circuit comprising:
two charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
each of a second-stage charge pump circuit and a third-stage charge pump circuit includes a first configuration or a second configuration,
the first configuration is such that one of the voltage-boosting switches, which is provided on a side for adding the boosting voltage to the charging voltage, includes a plurality of switches, one ends of the switches are commonly connected to the capacitor, and different boosting voltages are applied to other ends of the switches, respectively, and
the second configuration is such that one of the charging switches, which is provided on a high-voltage side for charging the capacitor, includes a plurality of switches, one ends of the switches are commonly connected to the capacitor, and different boosting voltages are applied to other ends of the switches, respectively; and
a selecting unit configured to select one of the switches in the second-stage charge pump circuit and the third-stage charge pump circuit, during a boosting period or a charging period, based on the input voltage to a first-stage charge pump circuit or an output voltage from the first-stage charge pump circuit.

6. The charge-pump-type power supply circuit according to claim 5, wherein
the switches in the second-stage charge pump circuit includes two switches, and the switches in the third-stage charge pump circuit includes three switches,
either one of the different boosting voltages and the different charging voltages in the second-stage charge pump circuit include the input voltage to the first-stage charge pump circuit and the output voltage from the first-stage charge pump circuit, and
either one of the different boosting voltages and the different charging voltages in the third-stage charge pump circuit include the input voltage to the first-stage charge pump circuit, the output voltage from the first-stage charge pump circuit, and an output voltage from the second-stage charge pump circuit.

7. A charge-pump-type power supply circuit comprising:
a plurality of charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
one of the voltage-boosting switches, which is provided on a side for adding the boosting voltage to the charging voltage in a second-stage charge pump circuit and subsequent-stage charge pump circuits, includes a plurality of switches,
one ends of the switches are commonly connected to the capacitor, and
different boosting voltages are applied to other ends of the switches, respectively; and
a selecting unit configured to select one of the switches, during a boosting period, based on at least the input voltage to a first-stage charge pump circuit or an output voltage from the first-stage charge pump circuit.

8. A charge-pump-type power supply circuit comprising:
a plurality of charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
one of the charging switches, which is provided on a high-voltage side for charging the capacitor in a second-stage charge pump circuit and subsequent-stage charge pump circuits, includes a plurality of switches,
one ends of the switches are commonly connected to the capacitor, and
different charging voltages are applied to other ends of the switches, respectively; and
a selecting unit configured to select one of the switches, during a charging period, based on at least the input voltage to a first-stage charge pump circuit or an output voltage from the first-stage charge pump circuit.

9. A charge-pump-type power supply circuit comprising:
a plurality of charge pump circuits connected in a cascade manner, each of the charge pump circuits including
two charging switches configured to charge a capacitor up to an input voltage; and
two voltage-boosting switches configured to add the input voltage to a charging voltage of the capacitor as a boosting voltage, wherein
each of a second-stage charge pump circuit and subsequent-stage charge pump circuits includes a first configuration or a second configuration,
the first configuration is such that one of the voltage-boosting switches, which is provided on a side for adding the boosting voltage to the charging voltage, includes a plurality of switches, one ends of the switches are commonly connected to the capacitor, and different boosting voltages are applied to other ends of the switches, respectively, and
the second configuration is such that one of the charging switches, which is provided on a high-voltage side for charging the capacitor, includes a plurality of switches, one ends of the switches are commonly connected to the capacitor, and different boosting voltages are applied to other ends of the switches, respectively; and
a selecting unit configured to select one of the switches in the second-stage charge pump circuit and the subsequent-stage charge pump circuits, during a boosting period or a charging period, based on at least the input voltage to a first-stage charge pump circuit or an output voltage from the first-stage charge pump circuit.
